(19) United States
(12) Patent Application Publication
(10) Pub. No.: US 2026/0077616 A1
(43) Pub. Date: Mar. 19, 2026

(54) PAINT-CLEANING CUPS AND RELATED METHODS

(71) Applicant: PAINT PUCK LLC, Pinellas Park, FL (US)

(72) Inventor: Dawson Cannon, Pinellas Park, FL (US)

(21) Appl. No.: 18/885,378

(22) Filed: Sep. 13, 2024

(51) Int. Cl. B44D 3/00; A46B 17/06; B08B 1/16; B44D 3/02; B44D 3/12

(52) U.S. Cl. CPC B44D 3/006; A46B 17/06; B08B 1/16; B44D 3/02; B44D 3/123; B44D 3/128

(57) ABSTRACT

Paint cleaning cups and related methods. A paint-cleaning cup includes a base, an outwardly extending collapsible wall, and a flange. The base has a first surface and second surface including a drip tray. The outwardly extending collapsible wall has a first end and a second end opposite the first end. The flange has a plurality of brush holders. The drip tray extends from the first end of the collapsible wall and the flange extends from the second end of collapsible wall. The collapsible wall is movable between an expanded position where the flange is spaced from the drip tray and a collapsed position where the flange is adjacent to the drip tray.

### FIELD OF THE DISCLOSURE

This disclosure relates generally to art supplies and, more specifically, to collapsible devices that provide collapsible paint brush support and cleaning cups.

### BACKGROUND

When using paint brushes, it is often desired to switch between different colors of paint depending on the painting being produced. The brush may desirably be rinsed to remove a first color of paint before dipping the brush in a second paint color. Rinsing containers used for rinsing brushes are typically bulky and are not easily portable.

### SUMMARY

The disclosed implementations relate to collapsible paint-cleaning cups that combine portability and collapsibility to allow users to paint on the go. The paint-cleaning cups are adjustable between a fully collapsed position and a fully expanded position and, thus, the paint-cleaning cup may be sized to contain different volumes of liquid.

The paint-cleaning cup disclosed includes a base including a drip tray, a collapsible wall, and a flange including brush holders. The wall is movable between an expanded position where the flange is spaced from the drip tray and a collapsed position where the flange is adjacent to the drip tray. The base has a central portion surrounded by the collapsible wall that has upwardly extending protrusions. The protrusions may be configured to efficiently and gently remove paint from a paint brush.

The flange of the paint-cleaning cup includes an inner rim and an outer rim. The inner rim may have inner brush holders and the outer rim may have outer brush holders. The inner brush holders may secure brushes within an interior of the paint-cleaning cup and the outer brush holders may secure brushes above the drip tray.

In a first implementation, a paint-cleaning cup includes a base, an outwardly extending collapsible wall, and a flange. The base has a first surface and a second surface including a drip tray. The outwardly extending collapsible wall has a first end and a second end opposite the first end. The flange has a plurality of brush holders. The drip tray extends from the first end of the collapsible wall and the flange extends from the second end of collapsible wall. The collapsible wall is movable between an expanded position where the flange is spaced from the drip tray and a collapsed position where the flange is adjacent to the drip tray.

In a second implementation, a method of using a paint-cleaning cup includes moving an outwardly extending collapsible wall of a paint-cleaning cup between a collapsed position and an expanded position. A base and the collapsible wall form an interior volume when in the expanded position. The paint-cleaning cup includes a base having a first surface and a second surface including a drip tray, the outwardly extending collapsible wall, and a flange including a plurality of brush holders. The method includes placing a suction cup of the first surface of the base on a surface. The first surface of the base includes the suction cup and an upwardly extending lip. The method includes filling the interior volume with liquid.

In further accordance with the foregoing first and/or second implementations, an apparatus and/or method may further comprise or include any one or more of the following:

In accordance with an implementation, the base, the collapsible wall, and the flange are integral.

In accordance with another implementation, the collapsible wall has a circular cross-section.

In accordance with another implementation, the collapsible wall is positioned within a dimensional envelope of the flange and the base when the collapsible wall is in the collapsed position.

In accordance with another implementation, the base includes an upwardly extending lip that forms a space to receive the collapsible wall when the collapsible wall is in the collapsed position.

In accordance with another implementation, the upward extending lip engages the flange when the collapsible wall is in the collapsed position.

In accordance with another implementation, the drip tray includes a palette.

In accordance with another implementation, the base includes an upward extending lip configured to allow space for paint to reside on the palette when the collapsible wall is in the collapsed position.

In accordance with another implementation, the palette includes dividers.

In accordance with another implementation, the palette includes wells positioned between the dividers.

In accordance with another implementation, the wells include oval wells.

In accordance with another implementation, the first surface of the base includes a flat surface and an upwardly extending lip.

In accordance with another implementation, the flat surface includes an annular flat surface.

In accordance with another implementation, the first surface of the base includes a central recess surrounded by the annular flat surface that forms a suction cup.

In accordance with another implementation, the first surface of the base includes a suction cup and an upwardly extending lip.

In accordance with another implementation, the upwardly extending lip forms a vacuum-release pull tab associated with the suction cup.

In accordance with another implementation, the first end of the collapsible wall has a first diameter and the second end of the collapsible wall has a second diameter smaller than the first diameter.

In accordance with another implementation, the collapsible wall tapers outwardly from the first end of the collapsible wall to the second end of the collapsible wall.

In accordance with another implementation, the collapsible wall further includes a plurality of inwardly and outwardly extending annular rings.

In accordance with another implementation, the outwardly extending annular rings include a first outwardly extending segment and a second outwardly extending segment. The inwardly extending annular rings include a first inwardly extending segment and a second inwardly extending segment. The first inwardly extending segment is positioned between the first outwardly extending segment and the second outwardly extending segment. The second outwardly extending segment is positioned between the first inwardly extending segment and the second inwardly extending segment.

In accordance with another implementation, the base has a central portion surrounded by the collapsible wall.

In accordance with another implementation, the central portion includes upwardly extending protrusions.

In accordance with another implementation, at least one of the upwardly extending protrusions has a circular cross-section.

In accordance with another implementation, the upwardly extending protrusions include first protrusions and second protrusions. The first protrusions have a first diameter and a first height and the second protrusions have a second diameter and a second height.

In accordance with another implementation, the flange includes an outer rim that includes the brush holders.

In accordance with another implementation, the flange further includes an inner rim and an outer rim. The brush holders include inner brush holders and outer brush holders. The inner rim includes the inner brush holders. The outer rim includes the outer brush holders.

In accordance with another implementation, the flange includes a vertical rim disposed between the inner rim and the outer rim.

In accordance with another implementation, the vertical rim includes an upward and inward slanting surface and a step.

In accordance with another implementation, the step is positioned between the inner rim and the upward and inward slanting surface.

In accordance with another implementation, the step includes an inward extending lip.

In accordance with another implementation, the flange includes a stiffener.

In accordance with another implementation, the stiffener is embedded in the flange.

In accordance with another implementation, the flange includes an outer rim and an inner rim. The stiffener is positioned between the outer rim and the inner rim.

In accordance with another implementation, the flange includes opposing flange surfaces and the stiffener is positioned between the opposing flange surfaces.

In accordance with another implementation, the stiffener is annular.

In accordance with another implementation, the stiffener includes cut-outs to accommodate the brush holders.

In accordance with another implementation, the stiffener includes metallic reinforcement, such as, aluminum.

In accordance with another implementation, the flange includes an inner rim including opposing inner surfaces and a rim bore surface extending between the opposing inner surfaces. The inner rim includes arced openings extending through the opposing inner surfaces and lateral openings extending through the rim bore surface that are coupled with the corresponding arced openings. The brush holders are defined by the arced openings and the lateral openings.

In accordance with another implementation, further including squeegees. Each squeegee in the form of flexible wipers or ribs is positioned between a pair of brush holders.

In accordance with another implementation, each brush holder is positioned between a pair of squeegees.

In accordance with another implementation, the flange includes opposing flange surfaces and a lateral surface extending between the opposing flange surfaces. The flange includes arced openings extending through the opposing flange surfaces and lateral openings extending through the lateral surface that are coupled with the corresponding arced openings. The brush holders are defined by the arced openings and the lateral openings.

In accordance with another implementation, the arced openings have first openings and second openings having a different size than the first openings.

In accordance with another implementation, the base, the collapsible wall, and the flange include a central axis. The arced openings include first arced openings located at a first distance from the central axis, second arced openings located at a second distance from the central axis, and third arced openings located at a third distance from the central axis. The second distance is greater than the first distance and the third distance is greater than the second distance.

In accordance with another implementation, the flange includes an inner rim and the brush holders are positioned on the inner rim of the flange.

In accordance with another implementation, the flange includes a through hole configured to receive a clip or hook.

In accordance with another implementation, the base includes an indentation that surrounds the through hole.

In accordance with another implementation, the indentation is U-shaped.

In accordance with another implementation, the method of using the paint-cleaning cup further includes inserting a handle of a paint brush into a brush holder of the flange. The flange includes an outer rim including opposing flange surfaces and a lateral surface extending between the opposing flange surfaces. The outer rim includes arced openings extending through the opposing flange surfaces and lateral openings extending through the lateral surface that are coupled with the corresponding arced openings. The brush holders are defined by the arced openings and the lateral openings.

In accordance with another implementation, the method of using the paint-cleaning cup further includes adding paint to wells of the drip tray and moving the collapsible wall from the expanded position to the collapsed position. The paint in the wells is covered by the flange when the collapsible wall is in the collapsed position.

### BRIEF DESCRIPTION OF THE DRAWINGS

FIG. 1 is an isometric view of a paint-cleaning cup in accordance with the teaching of this disclosure.

FIG. 2 is an isometric view of the paint-cleaning cup of FIG. 1 in the collapsed position.

FIG. 3 is a side elevation view of the paint-cleaning cup of FIG. 1, in its fully expanded condition.

FIG. 4 is a bottom view of the paint-cleaning cup of FIG. 1.

FIG. 5 is a perspective cross-sectional view of the paint-cleaning cup of FIG. 1 taken along line A-A of FIG. 3.

FIG. 6 is a bottom isometric view of the paint-cleaning cup of FIG. 1, in its fully expanded condition.

FIG. 7 is a top view of the paint-cleaning cup of FIG. 1.

### DETAILED DESCRIPTION

Although the following text discloses a detailed description of implementations of methods, apparatuses and/or articles of manufacture, it should be understood that the legal scope of the property right is defined by the words of the claims set forth at the end of this patent. Accordingly, the following detailed description is to be construed as examples only and does not describe every possible implementation, as describing every possible implementation would be impractical, if not impossible. Numerous alternative implementations could be implemented, using either current technology or technology developed after the filing date of this patent. It is envisioned that such alternative implementations would still fall within the scope of the claims.

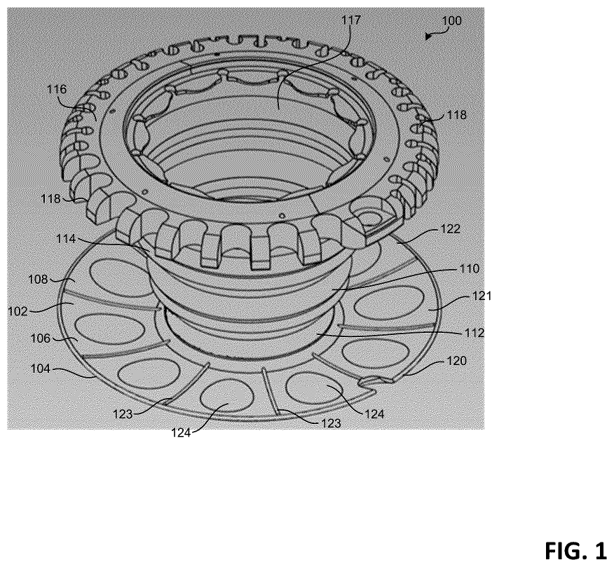

FIG. 1 is an isometric view of a paint-cleaning cup 100 in accordance with the teaching of this disclosure. The paint-cleaning cup 100 includes a base 102 having a first surface 104 and a second surface 106. The second surface 106 includes a drip tray 108.

The paint-cleaning cup 100 includes an outwardly extending collapsible wall 110 with a first end 112 and a second end 114 opposite the first end 112. The paint-cleaning cup 100 also has a flange 116. The flange 116 includes a plurality of brush holders 118 in the implementation shown. The drip tray 108 extends from the first end 112 of the collapsible wall 110 and the flange 116 extends from the second end 114 of wall 110 in the implementation shown.

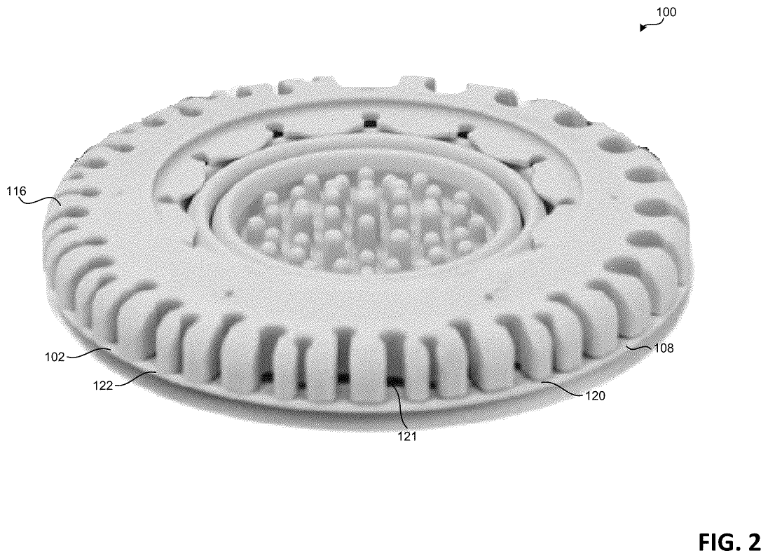

The wall 110 is movable between an expanded position where the flange 116 is spaced from the drip tray 108 as shown in FIG. 1 and a collapsed position where the flange 116 is adjacent to the drip tray 108 as shown in FIG. 2. The flange 116 covers the drip tray 108 when the wall 110 is in the collapsed position. The flange 116 may cover paint residing on the dip tray 108 when the wall 110 is in the collapsed position. The wall 110 and the base 102 form a cavity 117 that may receive a liquid to rinse paint brushes, for example. The cavity 117 may be referred to as an interior volume of the paint-cleaning cup 100.

The base 102, the wall 110, and the flange 116 are integral in the implementation shown. One or more the base 102, the wall 110, and/or the flange 116 may be separate components, however, that are coupled together. The paint-cleaning cup 100 and/or the drip tray 108 may be made of silicone or any other suitable material. The drip tray 108 may be configured to allow acrylic paint to be peeled off of the drip tray 108 after having dried in some implementations.

The wall 110 has a circular cross-section in the implementation shown. The wall 110 may have any other cross-section. The wall 110 may have an oval cross-section, a rectangular cross-section, and/or a quadrilateral cross-section as examples. The cavity 117 formed by the wall 110 may be shaped as a truncated pyramid in some examples. The wall 110 may be positioned within a dimensional envelope of the flange 116 and the base 102 when the wall 110 is in the collapsed position.

The base 102 includes an upwardly extending lip 120. The lip 120 may form a space 121 to receive the wall 110 when the wall 110 is in the collapsed position. The lip 120 engages the flange 116 when the wall 110 is in the collapsed position as shown in FIG. 2.

The drip tray 108 includes a palette 122. The lip 120 of the base 102 is configured to allow space for paint to reside on the palette 122 when the wall 110 is in the collapsed position. The palette 122 includes dividers 123 in the implementation shown. The dividers 123 keep contents on the palette 122 separate and/or deter paint on the palette 122 from mixing. The palette 122 includes wells 124 that are positioned between the dividers 123. The wells 124 may receive and/or retain paint. The wells 124 are shown being oval-shaped. The wells 124 may be any other shape. One or more of the wells 124 may be, for example, circular, triangular, and/or quadrilateral.

FIG. 2 is an isometric view of the paint-cleaning cup 100 of FIG. 1 in the collapsed position. The lip 120 of the base 102 is shown engaging the flange 116.

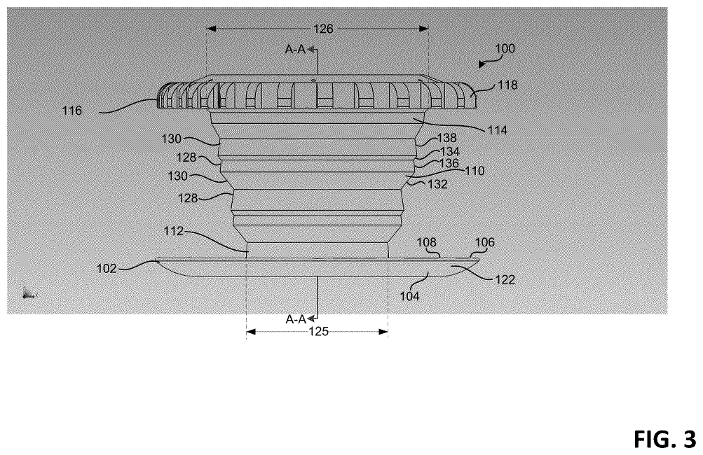

FIG. 3 is a side elevation view of the paint-cleaning cup 100 of FIG. 1, in its fully expanded position. The first end 112 of the wall 110 has a first diameter 125 and the second end 114 of the wall 110 has a second diameter 126 smaller than the first diameter 125. The wall 110 tapers outwardly from the first end 112 of the wall 110 to the second end 114 of the wall 110.

The wall 110 also includes a plurality of inwardly and outwardly extending annular rings 128 and 130. The outwardly extending annular rings 130 include a first outwardly extending segment 132 and a second outwardly extending segment 134. The inwardly extending annular rings 128 include a first inwardly extending segment 136 and a second inwardly extending segment 138. The first inwardly extending segment 136 is positioned between the first outwardly extending segment 132 and the second outwardly extending segment 134 and the second outwardly extending segment 134 is positioned between the first inwardly extending segment 136 and the second inwardly extending segment 138 in the implementation shown. The wall 110 may be configured to stabilize the paint-cleaning cup 100 when liquid is added to the cavity 117 because of the resulting hydrostatic pressure. the inwardly and outwardly extending annular rings 128, 130 may form concentric rings when the paint-cleaning cup 100 is in a collapsed position as a result of the outward tapering of the wall 110.

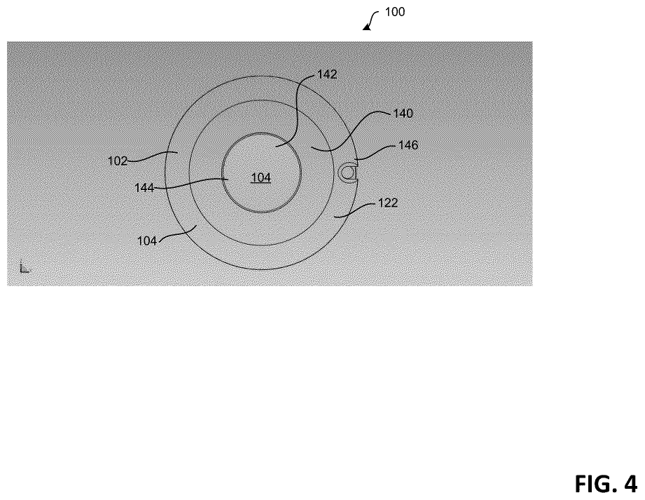

FIG. 4 is a bottom view of the paint-cleaning cup 100 of FIG. 1. The first surface 104 of the base 102 is shown including an annular flat surface 140. The annular flat surface 140 surrounds a central recess 142 that forms a suction cup 144. The first surface 104 of the base 102 includes the suction cup 144 and the lip 120 in the implementation shown. The lip 120 forms a vacuum-release pull tab 146 associated with the suction cup 144. Pulling the pull tab 146 of the suction cup 144 may enable the suction cup 144 to be detached from a surface to which it is adhered in some implementations. The suction cup 144 may be configured to adhere to a substantially horizontal surface when the paint-cleaning cup 100 is in the expanded position. The suction cup 144 may not be configured to adhere to the substantially horizontal surface when the paint-cleaning cup 100 is in the collapsed position in some implementations. The paint-cleaning cup 100 may alternatively not include a suction cup 144.

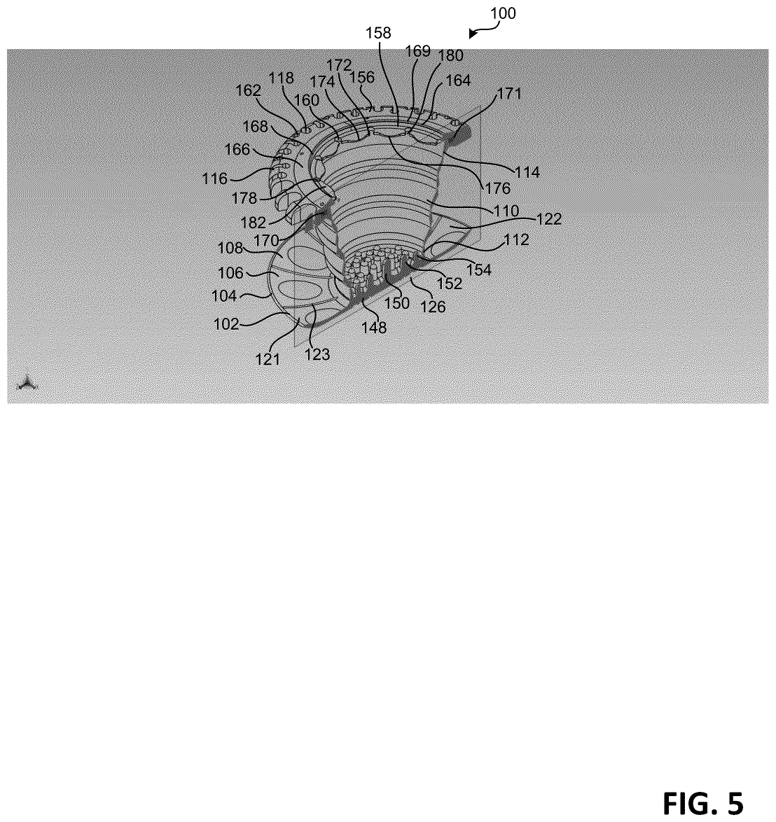

FIG. 5 is a perspective cross-sectional view of the paint-cleaning cup 100 of FIG. 1 taken along line A-A of FIG. 3. The base 102 of the paint-cleaning up 100 has a central portion 148 surrounded by the wall 110 in the implementation shown. The central portion 148 has upwardly extending protrusions 150. The protrusions 150 have circular cross-sections. The protrusions 150 may have any cross-section, however, such as oblong cross-sections, triangular cross-sections, quadrilateral cross-sections. The cross-section of the protrusions 150 of the paint-cleaning cup 100 of FIG. 5 inwardly taper as the protrusions 150 extend toward the flange 116 in the implementation shown. One or more of the protrusions 150 may have a consistent cross-section or taper outwardly.

The protrusions 150 of the paint-cleaning cup 100 include first protrusions 152 and second protrusions 154 in the implementation shown. The first protrusions 152 have a first diameter and a first height and the second protrusions 154 have a second diameter and a second height. The first diameter and the second diameter are different and the first height and the second height are different. The first diameter is shown being greater than the second diameter. The first height is shown being greater than the second height. The protrusions 150 are configured to be flexible and to be used to mechanically remove the paint from bristles of a paintbrush by interacting with the bristles as the bristles are cleaned in the cleaning solution. The cleaning solution may be any suitable liquid such as water.

The flange 116 has an outer rim 156 and an inner rim 158. The brush holders 118 include inner brush holders 160 and outer brush holders 162. The inner rim 158 has the inner brush holders 160 and the outer rim 156 has the outer brush holders 162. The inner brush holders 160 and/or the outer brush holders 162 may be omitted.

The flange 116 has a vertical rim 164 disposed between the inner rim 158 and the outer rim 156. The vertical rim 164 has an upward and inward slanting surface 166 and a step 168. The step 168 is positioned between the inner rim 158 and the upward and inward slanting surface 166. The step 168 may have an inward extending lip 169. The step 168 and/or the inward extending lip 169 may be configured to have bristles of the brushes rubbed against the step 168 and/or the inward extending lip 169 to remove excess liquid from the brush during the rinsing and/or cleaning process, for example.

The flange 116 is shown including a stiffener 170. The stiffener 170 provides increased rigidity for the paint-cleaning cup 100 to deter the flange 116 from significantly deforming and/or to deter liquid from inadvertently spilling out of the cavity 117 of the paint-cleaning cup 100 during use. The stiffener 170 may be configured to stabilize the paint-cleaning cup 100. The stiffener 170 is embedded within the flange 116 in the implementation shown. The flange 116 includes a space 171 in which the stiffener 170 is positioned.

The stiffener 170 is shown positioned between the outer rim 156 and the inner rim 158. The flange 116 has opposing flange surfaces 200, 202 and the stiffener 170 is positioned between the opposing flange surfaces 200, 202. The stiffener 170 may be positioned at any location on the paint-cleaning cup 100, however, or may be omitted.

The stiffener 170 may be annular. The stiffener 170 may alternatively be an open ring. The stiffener may have a rhombus shaped cross-section. The stiffener 170 may have cutouts in some implementations to accommodate the outer brush holders 162. The cutouts may be semi-circular. The cutouts may be formed in any manner. The cutouts may be formed by removing material from the stiffener 170, for example. The cutouts on the stiffener 170 may be omitted, however. The cutouts may be omitted when a width of the stiffener 170 fits between the brush holders 118 on the outer rim 156 and the inner rim 158 as an example.

The stiffener 170 may be made of metal such as aluminum. The stiffener 170 may alternatively be made of any suitable material. For example, the stiffener 170 may be made of plastic, metal, fiberglass, carbon fiber, and/or a hard silicone.

The flange 116 has the inner rim 158 including opposing inner surfaces 172, 174 and a rim bore surface 176 extending between the opposing inner surfaces 172, 174. The inner rim 158 has arced openings 178 extending through the opposing inner surfaces 172, 174 and lateral openings 180 extending through the rim bore surface 176. The lateral openings 180 are coupled with the corresponding arced openings 178. The brush holders 118 are defined by the arced openings 178 and the lateral openings 180. The lateral openings 180 are smaller than the arched openings 178 to retain a handle of a paint brush within the brush holder 118.

The paint-cleaning cup 100 includes squeegees 182. Each squeegee 182 in the form of flexible wipers or ribs is positioned between a pair of brush holders 118 in the implementation shown. Each brush holder 118 is positioned between a pair of squeegees 182 in the implementation shown. The squeegees 182 may be used to remove excess liquid from the bristles of brushes.

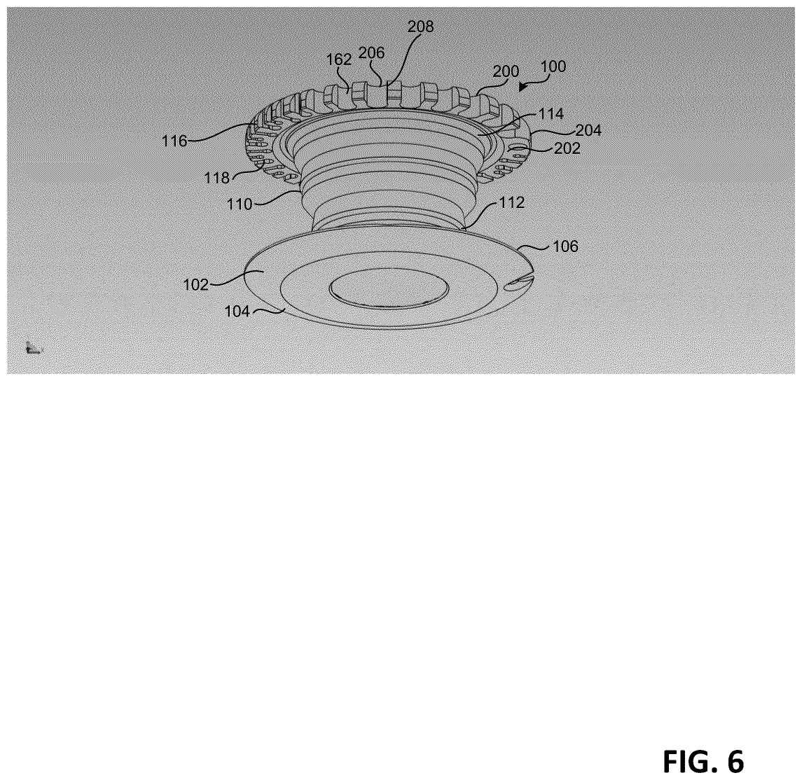

FIG. 6 is a bottom isometric view of the paint-cleaning cup 100 of FIG. 1, in its fully expanded condition. The flange 116 is shown having the opposing flange surfaces 200, 202 and a lateral surface 204 that extends between the opposing flange surfaces 200, 202. The flange 116 has arced openings 206 that extend through the opposing flange surfaces 200, 202 and lateral openings 208 that extend through the lateral surface 204. The lateral openings 208 are coupled with the corresponding arced openings 206. The brush holders 118 are shown being defined by the arced openings 206 and the lateral openings 208. The lateral openings 208 are smaller than the arched openings 206 to retain a handle of a paint brush within the brush holder 118. The arched openings 178 and/or 206 may be slightly undersized relative to a diameter of the corresponding paint brush to retain the paint brush within the brush holder 118.

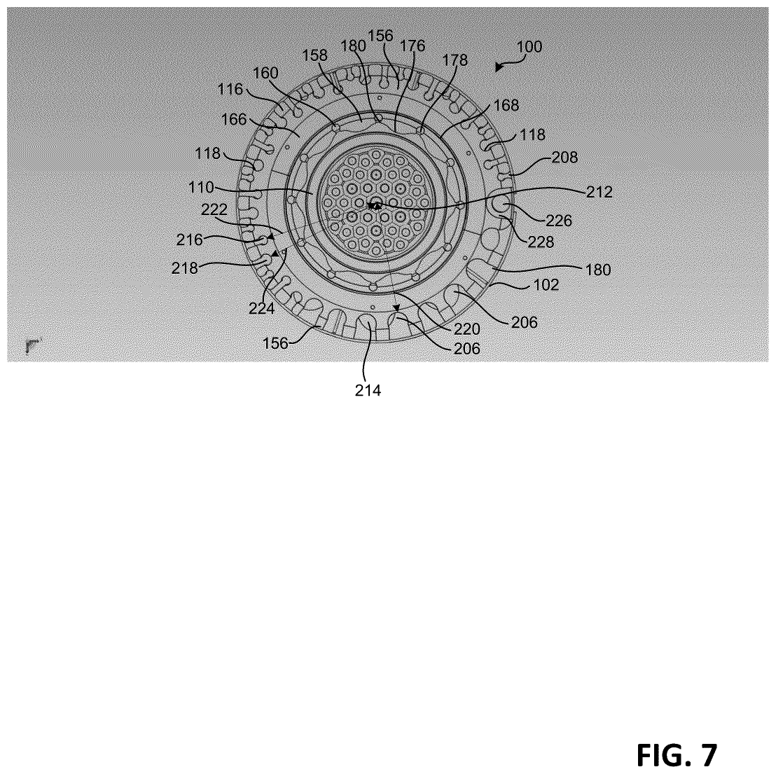

FIG. 7 is a top view of the paint-cleaning cup 100 of FIG. 1. The base 102, the wall 110, and the flange 116 are shown having a central axis 212. The arced openings 206 include first arced openings 214, second arched openings 216, and third arched openings 218. The first arced openings 214 are located at a first distance 220 from the central axis 212, the second arced openings 216 are located at a second distance 222 from the central axis 212, and the third arced openings 218 are located at a third distance 224 from the central axis 212. The second distance 222 is shown being greater than the first distance 220 and the third distance 224 is shown being greater than the second distance 222. The different distances 220, 222, 224 of the arched openings 214, 216, 218 allows paint brushes positioned within the brush holders 118 to be more spaced apart. Spacing the paint brushes apart may allow the paint brushes to more quickly dry and/or may deter paint on the paint brushes from mixing. The first arced openings 214 are positioned around a portion of the outer rim 156 and the second and third arched openings 216, 218 are interspersed around another portion of the outer rim 156. The first arced openings 214 are a different size from the second arced openings 216.

The flange 116 has a through hole 226 that is configured to receive a clip or hook. The clip or hook may allow the paint-cleaning cup 100 to be attached to an article such as a backpack or a beltloop on a pair of pants. The base 102 has an indentation 228 that surrounds the through hole 226 in the implementation shown. The indention 228 is shown being U-shaped. The indentation 228 may be differently shaped. The through hole 226 and/or the indentation 228 may be omitted in other examples.

The foregoing description is provided to enable a person skilled in the art to practice the various configurations described herein. While the collapsible paint-cleaning cup has been particularly described with reference to the various figures and configurations, it should be understood that these are for illustration purposes only and should not be taken as limiting the scope of the collapsible paint-cleaning cup.

1. A paint-cleaning cup, comprising:
a base having a first surface and second surface comprising a drip tray;
an outwardly extending collapsible wall comprising a first end and a second end opposite the first end; and
a flange comprising a plurality of brush holders,
wherein the drip tray extends from the first end of the collapsible wall and the flange extends from the second end of collapsible wall,
wherein the collapsible wall is movable between an expanded position where the flange is spaced from the drip tray and a collapsed position where the flange is adjacent to the drip tray.

2. The paint-cleaning cup of claim 1, wherein the base, the collapsible wall, and the flange are integral.

3. The paint cup of claim 1, wherein the collapsible wall has a circular cross-section.

4. The paint-cleaning cup of claim 1, wherein the collapsible wall is positioned within a dimensional envelope of the flange and the base when the collapsible wall is in the collapsed position.

5. The paint-cleaning cup of claim 1, wherein the base comprises an upwardly extending lip forming a space to receive the collapsible wall when the collapsible wall is in the collapsed position, wherein the upward extending lip engages the flange when the collapsible wall is in the collapsed position.

6. (canceled)

7. The paint-cleaning cup of claim 1, wherein the drip tray comprises a palette, wherein the base comprises an upward extending lip configured to allow space for paint to reside on the palette when the collapsible wall is in the collapsed position, wherein the palette comprises dividers, and wherein the palette comprises wells positioned between the dividers.

8-11. (canceled)

12. The paint-cleaning cup of claim 1, wherein the first surface of the base comprises a flat surface and an upwardly extending lip, wherein the flat surface comprises an annular flat surface, wherein the first surface of the base comprises a central recess surrounded by the annular flat surface that forms a suction cup.

13-14. (canceled)

15. The paint-cleaning cup of claim 1, wherein the first surface of the base comprises a suction cup and an upwardly extending lip, wherein the upwardly extending lip forms a vacuum-release pull tab associated with the suction cup.

16. (canceled)

17. The paint-cleaning cup of claim 1, wherein the first end of the collapsible wall has a first diameter and the second end of the collapsible wall has a second diameter smaller than the first diameter.

18. The paint-cleaning cup of claim 1, wherein the collapsible wall tapers outwardly from the first end of the collapsible wall to the second end of the collapsible wall.

19. The paint-cleaning cup of claim 1, wherein the collapsible wall further comprises a plurality of inwardly and outwardly extending annular rings, wherein the outwardly extending annular rings comprise a first outwardly extending segment and a second outwardly extending segment, the inwardly extending annular rings comprise a first inwardly extending segment and a second inwardly extending segment, the first inwardly extending segment positioned between the first outwardly extending segment and the second outwardly extending segment, the second outwardly extending segment positioned between the first inwardly extending segment and the second inwardly extending segment.

20. (canceled)

21. The paint-cleaning cup of claim 1, wherein the base has a central portion surrounded by the collapsible wall, wherein the central portion comprises upwardly extending protrusions, wherein at least one of the upwardly extending protrusions has a circular cross-section, wherein the upwardly extending protrusions comprise first protrusions and second protrusions, the first protrusions having a first diameter and a first height, the second protrusions having a second diameter and a second height.

22-24. (canceled)

25. The paint-cleaning cup of claim 1, wherein the flange comprises an outer rim comprising the brush holders.

26. The paint-cleaning cup of claim 1, wherein the flange further comprises an inner rim and an outer rim, wherein the brush holders comprise inner brush holders and outer brush holders, the inner rim comprising the inner brush holders, the outer rim comprising the outer brush holders, wherein the flange comprises a vertical rim disposed between the inner rim and the outer rim, wherein the vertical rim comprises an upward and inward slanting surface and a step, wherein the step is positioned between the inner rim and the upward and inward slanting surface, wherein the step comprises an inward extending lip.

27-30. (canceled)

31. The paint-cleaning cup of claim 1, wherein the flange comprises a stiffener, wherein the stiffener is embedded in the flange.

32-38. (canceled)

39. The paint-cleaning cup of claim 1, further comprising squeegees, wherein each squeegee in the form of flexible wipers or ribs is positioned between a pair of brush holders, wherein each brush holder is positioned between a pair of squeegees.

40. (canceled)

41. The paint-cleaning cup of claim 1, wherein the flange comprises opposing flange surfaces and a lateral surface extending between the opposing flange surfaces, wherein the flange comprises arced openings extending through the opposing flange surfaces and lateral openings extending through the lateral surface that are coupled with the corresponding arced openings, the brush holders defined by the arced openings and the lateral openings.

42. The paint-cleaning cup of claim 41, wherein the arced openings have first openings and second openings having a different size than the first openings.

43. The paint-cleaning cup of claim 41, wherein the base, the collapsible wall, and the flange comprise a central axis, the arced openings comprise first arced openings located at a first distance from the central axis, second arced openings located at a second distance from the central axis, and third arced openings located at a third distance from the central axis, wherein the second distance is greater than the first distance, and the third distance is greater than the second distance.

44. (canceled)

45. The paint-cleaning cup of claim 1, wherein the flange comprises a through hole configured to receive a clip or hook.

46-50. (canceled)
